(19) United States
(12) Patent Application Publication
(10) Pub. No.: US 2002/0159598 A1
(43) Pub. Date: Oct. 31, 2002

(54) System and method of dynamic key generation for digital communications

(75) Inventors: Itzhak I. Rubinstein, Tenafly, NJ (US); Daniel L. Randall, Dover, NH (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: KeyGen Corporation, Manchester, NH (US)

(21) Appl. No.: 10/021,268

(22) Filed: Dec. 7, 2001

Related U.S. Application Data
(63) Continuation-in-part of application No. 09/182,154, filed on Oct. 29, 1998, now abandoned.
(60) Provisional application No. 60/063,919, filed on Oct. 31, 1997.
(60) Provisional application No. 60/254,460, filed on Dec. 8, 2000.

(51) Int. Cl. H04L 9/00

(52) U.S. Cl. 380/259

(57) ABSTRACT

An encryption system and method for generating encryption keys between sender and receiver for a symmetric-key encryption system begins with an initialization step on both ends of the communication channel, in which a initialization string is exchanged between sender and receiver by secure methods. Thereafter, a pseudo-random-function generator operating on the initialization string is used to generate a master recovery key at both ends. The master recovery key is operated on by a succession of pseudo-random-function generators to produce an encryption key, which is used to encrypt data at the sender, creating ciphertext, and decrypt at the receiver. After a block of ciphertext is transmitted and received, a new encryption key is generated by subjecting the master recovery key to another pseudo-random-function, and adding entropy by means of still another pseudo-random function operating on the current ciphertext. The method also provides error correction and detection on two levels, detecting transmission errors on one level, and loss of synchronization on another level. Errors in synchronization without errors in transmission are used to detect intrusion by unauthorized communications.

### RELATED APPLICATIONS

This application is a continuation-in-part of U.S. application Ser. No. 09/182,154, filed Oct. 29, 1998, which claims the benefit of U.S. Provisional Application No. 60/063,919, filed on Oct. 31, 1997. This application further claims the benefit of U.S. Provisional Application No. 60/254,460, filed on Dec. 8, 2000. The entire teachings of the above applications are incorporated herein by reference.

U.S. application No. Ser. No. 09/182,154 includes a computer listing on microfiche media, consisting of one original fiche containing 43 frames. The entire teachings of the computer listing on the microfiche media is also incorporated herein by reference.

### FIELD OF THE INVENTION

This invention relates to data encryption, and more specifically to symmetric-key encryption methods in which the keys are constantly updated and changed by pseudo-random-function techniques.

### BACKGROUND OF THE INVENTION

It should be noted that, throughout this application, the words “encrypt” and “encipher”, and variations thereof, are used interchangeably. The same is true for “decipher” and “decrypt”.

Encryption systems are well known and increasingly important to provide secure communications in a variety of domains. Among the most important of these is data communications over computer networks such as the Internet. Internet communications take place using a variety of communications media, including land lines, microwave, and satellite.

Much of this communication can be easily intercepted using well developed technologies. As a result, it is essential that the contents of this communication is encrypted in a manner that cannot be easily decrypted by unauthorized listeners.

A number of technologies have been developed for this purpose. Many of the most popular use “keys”, which consist of strings of characters, and/or numbers, which are used to encrypt plain text messages into encrypted form called ciphertext, by means of mathematical functions, or algorithms, specially chosen for this purpose.

Thus, the following formula describes encryption of a message into cyphertext, where:

c¹=f₁(p,k)

c₁=ciphertext message

f₁=the encryption algorithm

p=plain text message

k=encryption key

For many encryption systems, called “symmetric key encryption”, the decryption uses the same key as encryption, so that

P=f₂(c₁,k)

where f₂ is the decryption algorithm.

In all encryption systems, both the sender and receiver must have the key(s) in order to use the system. Thus, the key(s) must first be transmitted from the sender to the receiver prior to any message communication for symmetric key systems. This is typically done by in-hand delivery, courier, secure telephone line, public-private key systems, or other secure means.

However, some systems do not require secure means to transmit keys. A popular method of this type is the so-called public key system. Such a system was described by Diffie and Hellman “New Directions in Cryptography”, IEEE Transactions on Information Theory (November 1976). This system obviates the need that sender and receiver agree on a key before encryption/decryption takes place. In such a system, the sender and receiver each place their enciphering key in a public file, but do not publicly disclose their corresponding deciphering key. Furthermore, the relations between each enciphering and deciphering key pair is such that one cannot easily be determined from the other. The relation between each pair is as follows:

D_{A}(E_{A}(M))=M

Where

E_{A}=the enciphering key;

D_{A}=the corresponding deciphering key; and

M=the message to be transmitted.

In this type of system only the sender may decipher a message M that the receiver has enciphered using the sender's public key E_{A}, since only the sender has the corresponding deciphering key D_{A}.

For this system to be practical, it is necessary that both E_{A} and D_{A} be efficiently computable; and that furthermore, it should not be computationally feasible for an intruder to determine D_{A} given E_{A}. This does not mean that such a determination is impossible, but only that it would be extremely difficult and time consuming for the intruder to compute D_{A}. Frequent changing of the public keys further makes this system practical.

However, the availability of faster and more powerful computers, as well as the general availability of the public key system algorithms does make public key far from foolproof. Vulnerability is expected to increase as the technology improves.

The so-called symmetric key system has also been widely used. This system uses the same key for encryption and decryption. The system is vulnerable in that, once the key has been discovered, the ciphertext may be easily deciphered if the enciphering algorithm is known. And, to be commercially successful, a large number of copies of an enciphering system must be sold. So most commercially successful systems are vulnerable in that only the key must be discovered, since the enciphering/deciphering algorithms are widely available.

Furthermore, most enciphering algorithms used are decipherable even without knowledge of the algorithm used, if sufficient computing power and time is applied to the problem.

The current invention improves on the existing technology in three major ways. First of all, the current invention operates by constantly changing the key used for encryption during enciphering and transmission of the messages by calculating the new keys simultaneously at the sending and receiving ends. The data to be encrypted is organized into blocks of arbitrary size. Each block is encrypted into ciphertext using a different key. The keys are calculated synchronously at both sender and receiver ends by pseudo-random functions, thus making it extremely difficult for an intruder to detect a pattern in the way the keys change. However, both sender and receiver will generate the identical keys at identical points of the transmission. And means are provided to resynchronize the system when synchronization is lost.

Secondly, algorithms used for changing the keys are such that, in order to detect them, an unauthorized listener must not only know the key used to initiate the encryption link; the listener must have accurately intercepted all messages between the sender and receiver since the first transmission using the current invention in order to determine successive keys. This is because successive keys are further modified by mathematical functions which depend upon the cyphertext transmitted, as well as the previously used keys.

Third, neither the keys nor any information from which keys can be determined is transmitted over the link, or otherwise revealed to the world.

And, finally, the current system is not married to any particular algorithm for enciphering and deciphering, but may be used with a large variety of such algorithms.

As a result of the foregoing, this invention enables symmetric-key to be used with the same, or higher levels of security as competing systems, despite widespread knowledge of the system's operation, consistent with the system's commercial success.

### SUMMARY OF THE INVENTION

It is an object of the present invention to provide a method for automatically generating and updating encryption keys for use in symmetric-key encryption systems. It is a further object of this invention to provide such a method which includes several levels of error detection and correction, whereby the system is able to discern the difference between transmission errors and attempt at intrusion, and to take steps accordingly.

According to one aspect of the current invention, a method for symmetric-key encrypted transmission between a sender and receiver includes a series of steps, in order, as follows: first is the exchanging a initialization string by secure, external transmission between sender and receiver. Next is the generating a master recovery key variable by pseudo-random-function means operating on the initialization string at both sender and receiver, followed by the generating an encryption key by pseudo-random-function means operating on the master recovery key at both sender and receiver. Following this, the method includes encrypting a block of information into ciphertext by symmetric-key-encryption algorithm means utilizing the encryption key at the sender. Next, the ciphertext is transmitted to the receiver, followed by the decrypting of the ciphertext by symmetric-key-encryption algorithm means utilizing the encryption key at the receiver. Finally, a new encryption key is generated by pseudo-random-function means operating on the master recovery key and the encryption key. These steps are then repeated from the point of generating the encryption key, until the information to be transmitted is exhausted.

According to a further aspect of the invention, entropy is added to the new encryption key by pseudo-random-function means operating on the information block.

According to a still further aspect of the invention, error-detecting and correcting means are added, which is done only on a synchronization correcting basis.

According to one more aspect of the invention, synchronization correcting further includes calculating synchronization data at sender and receiver by pseudo-random function means operating on the current information block, including the synchronization data with the ciphertext transmitted to the receiver, and comparing the synchronization data received with the synchronization calculated.

According to still one further aspect of the invention, the method includes signaling resynchronization requests from receiver to sender, and acknowledging resynchronization requests. The steps of the method are then repeated from the point of generating the encryption key, until the information to be transmitted is exhausted.

According to a final aspect of the invention, the generating of the encryption key further includes the steps of generating a master key by pseudo-random function means operating on the master recovery key, generating an internal key by pseudo-random-number-function means operating on the master key; and performing pseudo-random number-function calculations on the internal key.

### BRIEF DESCRIPTION OF THE DRAWINGS

These, and further features of the invention, may be better understood with reference to the accompanying specification and drawings depicting the preferred embodiment, in which:

FIG. 1 depicts the first preferred embodiment in simplified flow chart form, showing both sender and receiver.

FIG. 2 depicts the method in more detailed flow chart form, at the sender end only.

FIG. 3 depicts a block diagram of the hierarchy of key generation.

FIG. 4 depicts a flow diagram showing the key generation logic flow.

FIG. 5 depicts a flow diagram of the synchronization error detection and correction logic.

FIG. 6 depicts the second preferred embodiment in simplified flow chart form, showing both sender and receiver.

FIG. 7 depicts the third preferred embodiment in simplified flow chart form, showing both sender and receiver.

### DESCRIPTION OF THE PREFERRED EMBODIMENTS OF THE INVENTION

The preferred embodiment of the current invention is in the form of a software tool kit library, called “ASK” which may be easily integrated into a users encryption and decryption system.

The ASK system utilizes a number of pseudo-random number generation (“PRN”) algorithms to implement its functions. These PRN functions are of such a nature that the outputs appear to be random, but are, in effect deterministic. To illustrate, consider the deterministic pseudo-random function PRN1:

n[1]=PRN1(a₁,a₂, . . . aₙ,); and (1)

n[I]=PRN1(a₁,a₂, . . . aₙ, n[I−1]) (2)

wherein

I=the number of times PRN1 has been evaluated previously;

n[I]=the number produced by the I^{th} iteration of the function;

a₁ through aₙ=arguments.

It is seen that each time that PRN1 is evaluated the result n[I] is dependent upon the previous value n[I−1]. Furthermore, if a sender and a receiver independently evaluate this function by first executing equation (1) above and then repeatedly executing equation (2), they will both calculate identical values of n[l] for identical values of I. And finally, if the functions is carefully chosen, the values of n[l] will not degenerate into a single, repeating value for large values of I.

In the current invention both encryption and decryption depend upon a series of keys which are generated beginning with the identical single master key. Upon the occurrence of a change event “EC”, identically detectable by both sender and receiver, the current encryption key is changed by both sender and receiver, using a PRN function and an algorithm which depends on the PRN function. That is

k[I]=fₙ(PRNₙ[I]) (3)

k[I]=the Ith value of the encryption key

fₙ=the algorithm used to produce key k[I]; and

PRNₙ=the pseudo-random function used by fₙ.

Thus, once the system has been initialized, the keys produced by the sender and receiver will be changed to the same value upon occurrence of the change event EC. In the current invention this event is dependent upon the number of characters of ciphertext transmitted. As a result, the keys will change synchronously at the sender and receiver, although synchronous in this context means after a certain amount of the message has been sent and received.

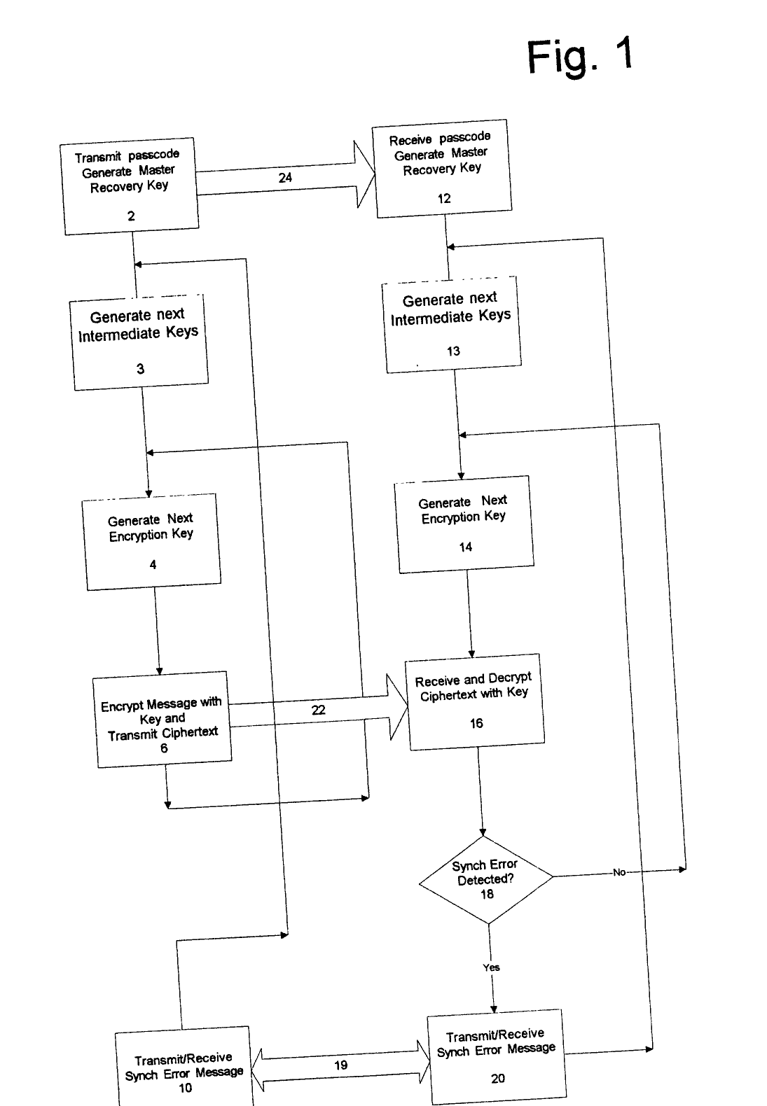

A simplified version of this system is shown in the flow chart of FIG. 1. Referring to this figure, two columns appear, the left-most representing processes at the sending end, and the right-most representing processes at the receiving end.

In operation, a initialization string must be selected by the sender, and transmitted 2 to the receiver 12 by some secure means, typically external to the data communication channel to be used to later transmit the cyphertext. Secure transmittal may be by any number of means: by private mail, courier, secure telephone line may be used. Data communications means may also be used over the same channel intended for use in the communications to follow, using an alternative encryption method, such as public-private key encryption.

One of the critical features of this invention is that the initialization string is exchanged once and only once. Thereafter, the encryption keys are automatically identically generated by the system independently at both sender and receiver end, and are periodically identically changed, based on this history of the data transmission. Thus, even if the initialization string is intercepted by an intruder, the intruder will not be able to calculate the current encryption key without having the entire history of the communication between the sender and receiver, as well as knowing the precise encryption and decryption algorithms used.

Next, the Master Recovery Key is generated 2, 12 at both the sender and receiver ends by applying one or more identical PRN functions at both sender and receiver. These PRN function are typically programmed into the system. Using this Master Recovery Key, the sender and receiver identically calculate one or more Intermediate Keys 3, 13, from which an Encryption Key 4, 14 is generated at both sender and receiver using one or more PRN functions.

It should be reiterated that the keys so generated will be identical at the sender and receiver, even though, to anyone observing the key generation, there appears to be a random relationship between the new keys and the previous keys, or between the keys and the initialization string.

Still referring to FIG. 1, the next block of information is then encrypted 6 into ciphertext at the sender, and is transmitted 22 to the receiver, where is it received and decrypted 16 using the same encryption key as used by the sender, and which has been independently calculated by the receiver.

Synchronization data can be included in the ciphertext which has been transmitted, and the receiver has means to independently calculate the synchronization data. If the synchronization data calculated does not correspond to the synchronization data received, a synchronization error is indicated 18, and a synchronization error message 20 is signaled 19 from the receiver to the sender. The Sender acknowledges 19 the error message, and both sender and receiver will then generate a new intermediate Key 3, 13, from which new encryption keys are generated.

Again, it should be reiterated that the Master Recovery Key can remain unchanged throughout the life of the system operation unless the users of the system choose to change it regularly. If the system has been compromised, however, the sender and receiver may exchange new initialization keys.

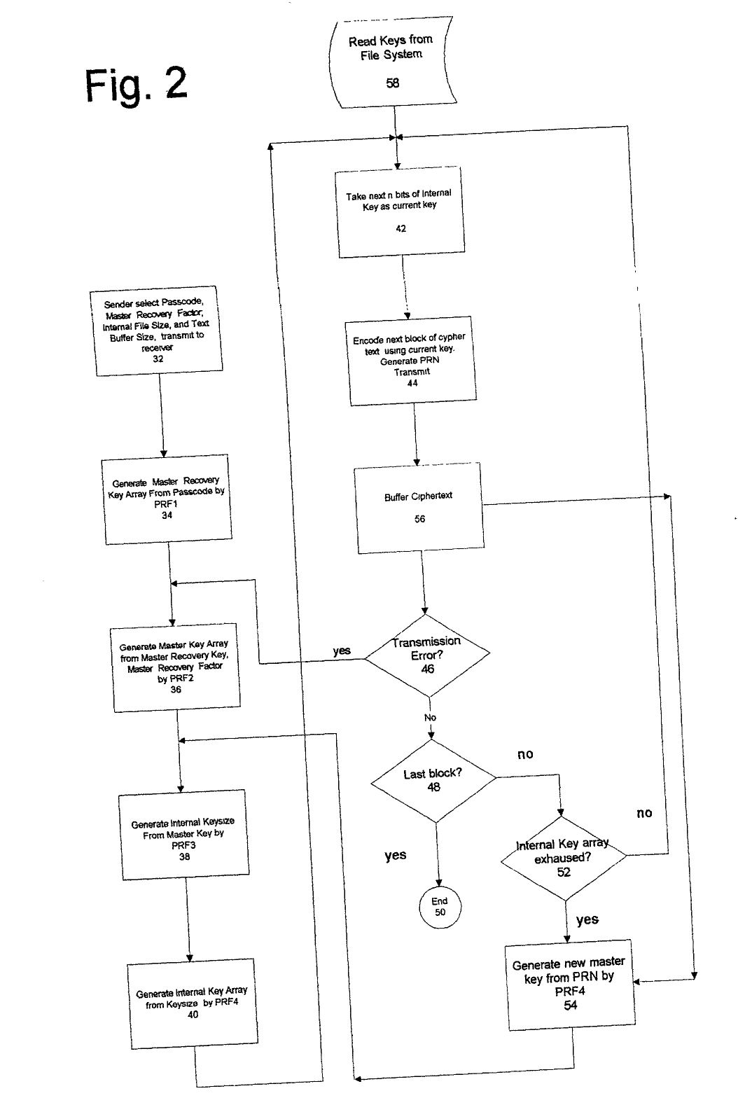

The exact structure of the Intermediate Keys and their relationship to the rest of the system may be understood by reference to FIG. 2. The logic of FIG. 2 applies to both the sender and receiver. The functions described in FIG. 2 are discussed in detail below.

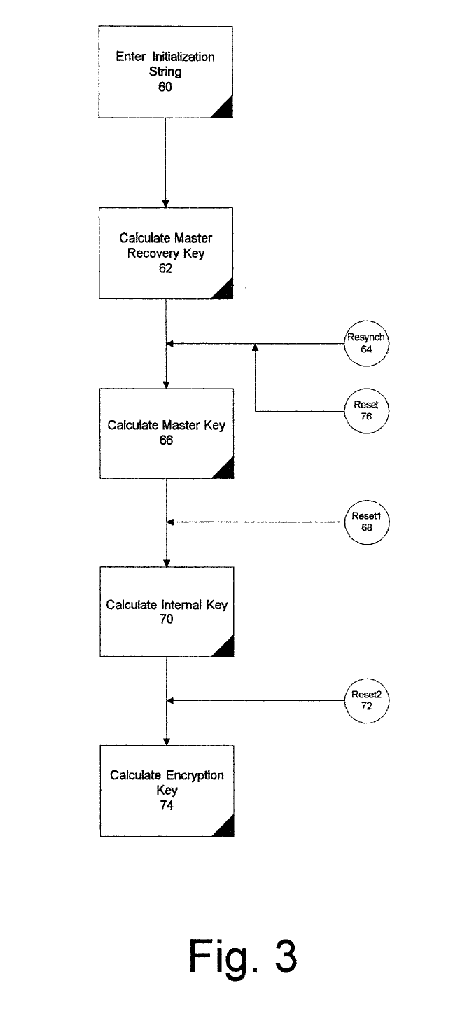

FIG. 3 is a block diagram which depicts the relationship of the keys, and the points at which these keys are calculated and recalculated.

Referring to FIG. 3, it is seen that after exchange of the Initialization String 60 and calculation of the Master Recovery Key 62, the Master Key is calculated, and is further recalculated whenever a re-synchronization is requested.

The Master Key is also re-calculated 66 when Reset 76 occurs, that is, when the Internal Key array and the previous Master Key array have been exhausted.

The Internal Key array is recalculated 70 when the previous Internal Key array has been exhausted, triggering Reset1 68. And the Encryption Key is recalculated 74 whenever a new block of data is encrypted into cyphertext, triggering Reset2 72.

The Internal Key is calculated 70 from the Master Key, and it is recalculated through path Reset1 68 whenever the Internal Key array 70 is exhausted. The Encryption Key 74 is recalculated from the Internal Key array 70 through path Reset2 72 whenever a block of ciphertext has been transmitted.

The ASK software facilitates the method described above by providing a library of functions which generate the keys which can then be integrated into the user's existing (host) encryption system. It is also expected that the user's existing software will provide the communications protocols, such as TCP/IP, which facilitate the basic communications functions, as well as byte-by-byte error detection and correction.

The basic functions performed by ASK are as follows:

1. A function is provided to generate a Master Recovery Key from a initialization string supplied by the user.

2. A second function is provided to generate a Master Key from the Master Recovery Key.

3. A third function is provided to generate the Internal Key from the Master Key.

4. A non-PRN function is used to generate the Encryption Key from the Internal Key after a block of data is encrypted.

5. A fourth PRN function is provided to change the Master Key after the Internal Key Array is exhausted, using randomness, or entropy, provided by the ciphertext itself.

According to the preferred embodiment, the invention operates in concert with a Host Application, which performs the actual encryption and decryption in accordance with an encryption algorithm utilizing a symmetric key. The key itself is generated, repeatedly regenerated and changed, and calculated identically by the system at both sender and receiver ends, as described in the following sections.

Initialization

Referring now to FIG. 2, it is seen that the first step of the encryption process requires the exchange of a initialization string or password between the sender and receiver 32. The initialization string is of any length desired. The exchange can be by any number of secure methods, including courier delivery, voice communication by secure telephone, or by another existing encryption method, such as a public key system. Regardless of what method is chosen, the initialization string should be exchanged externally to the communication channel in which encryption by means of the current invention will take place. It is done once and only once, during initialization. Even when re-synchronization is required, there is no further exchange of initialization string between sender and receiver.

After initialization, there are no further exchanges of keys required between sender and receiver at any time during the operation of this system. Although the encryption keys are being constantly changed during operation of the system, the changes are calculated independently at both sender and receiver ends.

Still referring now to FIG. 2, both the sender and receiver must use identical parameters including Master Recovery Factor, Internal File Size, and Text Buffer size 32. These parameters are normally fixed when the ASK library is incorporated into the host software.

After the initialization string is exchanged 32, the Master Recovery Key (MRK) is generated 34 by use of a pseudo-random number (PRN) function. This MRK is an array of 160-bytes generated according to the following equation:

MRK[I]=SEED[N]⊕SEED[N−1](INT(I/N)+170+N−1) (4)

where:

N=0 . . . SEED_LENGTH-1.

SEED=INITIALIZATION STRING

I=INDEX (0 THROUGH 159)

SEED_LENGTH=NUMBER OF CHARS IN INITIALIZATION STRING

⊕ is an exclusive OR function

INT(x) is the INTEGER value of x

This calculation of the Master Recovery Key is done once, and only once, by both sender and receiver from the initialization string. The master recovery key is used during loss of synchronization, as will be described infra.

The next step on both send and receive ends is the generation of the Master Key 36 (MK) by a second pseudo-random number function in accordance with the following function (PRF1):

MK[I]=MRK[I]⊕MRK[ROTR(MRK[I], MRF)MOD 40] (5)

where

I=INDEX (0 THROUGH 31)

ROTR is the Rotate Right function, recycling the prior least significant bit to the most significant bit position

MRF is an arbitrary integer which is fixed in the host application

MOD 40 is the modulo 40 function, whereby nMOD 40=remainder of n/40 The Master Key is thus an array of 32 bytes, each 8 bits in length. This master key is changed at intervals during the encrypted transmission, even when there is no loss of synchronization.

Next, an Internal Key (IK) is generated 40 from the Master Key by yet another PRN function, in accordance with the following formula:

IKᵢ[I]=MKᵢ[I]⊕MK[MKᵢ[I]SHR 1] where I=0 . . . KeySize (6)

where:

I=INDEX (0 THROUGH 99)

SHR 1 is the shift right by 1 bit function, with the shifted bit lost; and KeySize is calculated 38 by the following formula, which is also a PRN function:

KeySizeᵢ=(100−(MKᵢ[MKᵢ[127]SHR 1)]MOD 32)) (7)

It is apparent that, because KeySize subtracts a number modulo 32 from 100, KeySize must be a value between 69 and 100. Thus, the Internal Key array is of a size between 69 and 100 bytes.

Finally, the first Encryption Key is generated 42 by selecting the first M bytes of the Internal Key array, where the value M is an arbitrary integer which is fixed in the host application, according to the following equation:

EK[I]=IKᵢ[I+K] (8)

where:

I=INDEX (0 THROUGH M)

K=number of blocks transmitted

For initialization, K=0.

At this point, the system has reached the end of the initialization phase, and encryption, and transmission of the encrypted message, may begin. It should be emphasized that the calculations of equations (4) through (7) have been performed by both sender and receiver, with identical results at both the send and receive ends.

Normal Mode Transmission

When initialization is complete, normal transmission may begin. Transmission requires encrypting of the message text using the Encryption Keys which has been generated by the process described above. The encryption algorithm used is not the subject of this patent; any one of a number of symmetric key algorithm may be selected as part of the host software package. Thus, as new algorithms become available, they may be easily integrated with the current invention.

The host software also determines the transmission block size, which may be as large or small as desired. A complete block of text is encrypted using the Encryption Key on the sender end of the transmission, resulting in a block of ciphertext which is transmitted 44 to the receiver. It is decrypted using the same Encryption Key, which has been independently generated at the receiver end.

Next the cyphertext is buffered 56, and a portion of this buffer is used to supply entropy to the next master key calculation 54.

If there has been no transmission error detected 46, and if the last block of data has not yet been encrypted 48, then the system tests to determine if the Internal Key array has been exhausted 52. If it has not, then a new slice of the Internal Key array is selected 42 for the next Encryption Key, and the process continues.

If the Internal Key array has been exhausted, then a new Master key array is generated 54, and a new Internal Key array is also generated, beginning with the Internal Keysize calculation 38.

Note that if processing begins after a previous transmission, the keys are read from the file system 58, where they have been previously stored.

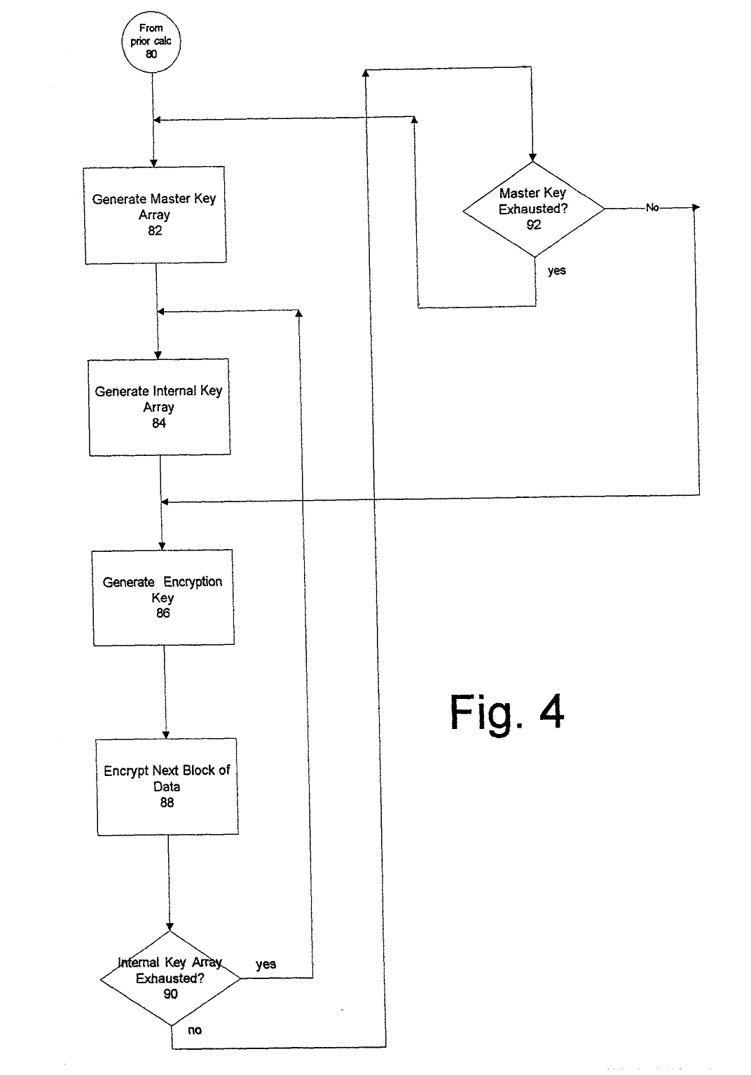

Following the end of the first block transmission, a new Encryption Key is generated by selecting the next M Bytes of the Internal Key array 42 as depicted in FIG. 4, in accordance with the equation (8), where K is now 1. After the second block, K is incremented to 2, etc.

Eventually the Internal Key array will be exhausted: that is, the value of I+K in equation (8) will exceed the size of the Internal Key array. A new Internal Key array will then be generated by the Master Key Change Process.

FIG. 4 depicts the relationship between the keys. The process starts with the prior calculation 80 of the Master Recovery Key. Next, the Master Key array is generated 82 from the Master Recovery Key, followed by generation of the Internal Key Array 84 from the Master Key. The Encryption Key is then generated 86 from the Internal Key Array, and the next block of information is encrypted into ciphertext 88, and transmitted from sender to receiver.

After this transmission the system tests to determine if the Internal Key array is exhausted 90. If so, a new Internal Key array is generated 84 from the Master Key, and the process continues. If not, the system tests to determine if the Master Key array is exhausted 92. If so, a new Master Key is generated 82 from the Master Recovery Key, and the process continues. If not, a new Encryption Key 86 is generated, and the process continues.

One of the problems of selecting pseudo-random functions is to avoid degenerative functions; that is, functions which, after a number of iterations, produce the same results over and over. One means of doing this is to add additional randomness, or entropy, from another function independent of the PRN function.

In the preferred embodiment, additional entropy is added into the Master Key array 36, as previously described and as depicted in FIG. 3. This entropy is derived from the block of ciphertext just transmitted. The system extracts a byte of entropy from the last block of Ciphertext using the function RandomByte, which reads 8 bits of the CipherFeedBack variable Value from pseudo-random locations determined by the current Master Key string. This entropy is stored in the RandomByte variable.

The Random byte variable is generated locally from CipherFeedBack variable, which is the first 128 bytes of the ciphertext buffer. The Random byte function picks 8 bits from this buffer. Which bits are selected depends upon the previous Master Key array, and is completely arbitrary.

Once the RandomByte variable is calculated, a new Master Key MKB is generated 36, defined by the following function (PRF2):

MKBᵢ₊₁[k]=(MKBᵢ[k]+MKBᵢ[(RBᵢ+k)MOD 127])MOD 255⊕MRKᵢ[CRC(MRKᵢ)+k)MOD 160] (9)

where

k=INDEX (0 THROUGH 31)

Rbᵢ=Randombyte calculated by (6)

CRC=cyclical redundancy check value

After the new Master Key array is calculated, a new Internal Key array is calculated 40 using equation (6) (PRF3), and a new Encryption Key is generated using equations (7) and (8).

As this process repeats, a new Encryption Key is repeatedly calculated, at both sender and receiver end, after each transmission of ciphertext, and the process repeats indefinitely.

Not only do the encryption keys change after every block; but it is apparent that, even if an intruder possesses the software by which the invention is implemented, the intruder must also have monitored the entire history of transmissions in order to calculate the next Encryption Key.

Synchronization and Errors

The current invention provides one means of error correction and detection: synchronization checks. Synchronization checks are used to detect and correct normal transmission errors which arise from noise in the transmission channels, etc. Although the ASK Toolkit provides a redundancy system for hosts which do not provide a byte-by-byte check, such error correction and detection is built into most communications protocols, such as TCP/IP.

The synchronization error check is used to detect intrusions of unauthorized transmissions. When synchronization checks are used in the absence of byte-by-byte checks, may indicate that transmission errors have occurred. However, when byte-by-byte checks are used as well, errors in synchronization indicate intrusions in which the incoming data is coming from an unreliable source.

Synchronization checks are made by inserting a 16-bit code into the ciphertext stream at times determined by the state of whether or not a new Master Key is being generated during the current block. Since the process of changing the current Master Key to a new value operates on entropy found in the current ciphertext block, the existence of errors in that block can cause de-synchronization. This is prevented by calculating a 16-bit ECD (error correction and detection) code and inserting it into the current ciphertext block at 16 pseudo-random locations obtained from the C++ function shown in Table 1.

This function returns, through reference, sixteen ordered pairs (word, bit) that denote sixteen unique, pseudo-random “bit-locations” in the current ciphertext block. The ciphertext block is then processed by a routine that relocates these 16 bits from their pseudo-random locations to the 16 empty bits appended to the end of this ciphertext block by the host application. The now-vacant “bit-locations” are then used to store the 16-bit Error Correction/Detection (ECD) code. In this method, the ECD code is stored at 16 pseudo-random locations in the current ciphertext block and the original, relocated bits are arranged in order at the end of this block. Determining the value of the ECD code or the source-locations of the relocated bits requires possession of the proper Master Recovery Key. The host application is now free to send this modified ciphertext block to a receiving host application.

The receiving host application then receives a modified ciphertext block and calls the above function to obtain the sixteen pseudo-random locations at which it expects to find the ECD code. The incoming ciphertext block is then processed by a routine that extracts the 16-bit ECD code from the sixteen pseudo-random “bit-locations.” The now-vacant “bit-locations” are then used to store the restored original values that were previously relocated to the 16 bits appended to the end of this block. The receiving host application is now free to decipher the de-modified ciphertext block.

Analysis of the extracted ECD code also serves to guarantee authenticity of the sender: A bogus sender will not be synchronized with the receiver and place the ECD code bits in the proper pseudo-random locations, or the ECD code itself will be wrong, denoting an out-of-sync error.

In the absence of byte-by-byte errors, the host may want to terminate reception, or take other defensive action. However, when byte-by-byte error detection indicates that uncorrectable transmission errors have occurred, the system must resynchronize at this point. The host system must provide means to signal resynchronization between sender and receiver, which is then accomplished according to the following section.

Resynchronization and Authentication

Resynchronization takes place when the host exchanges semaphores between sender and receiver commanding and acknowledging resynchronization. Then both sender and receiver use the Master Recovery Key to re-initialize the key generation process, which proceeds in exactly the same way as the original Initialization process.

Authentication requires that the sender demonstrate authority to transmit. This may be done at any time, but preferably after a previous transmission has been received from this sender, by transmitting an authentication code in the form of the CRC of the Master Key calculated by the last previous transmission. If the value received does not agree with the value previously calculated and stored by the receiver, an attempted intrusion is indicated.

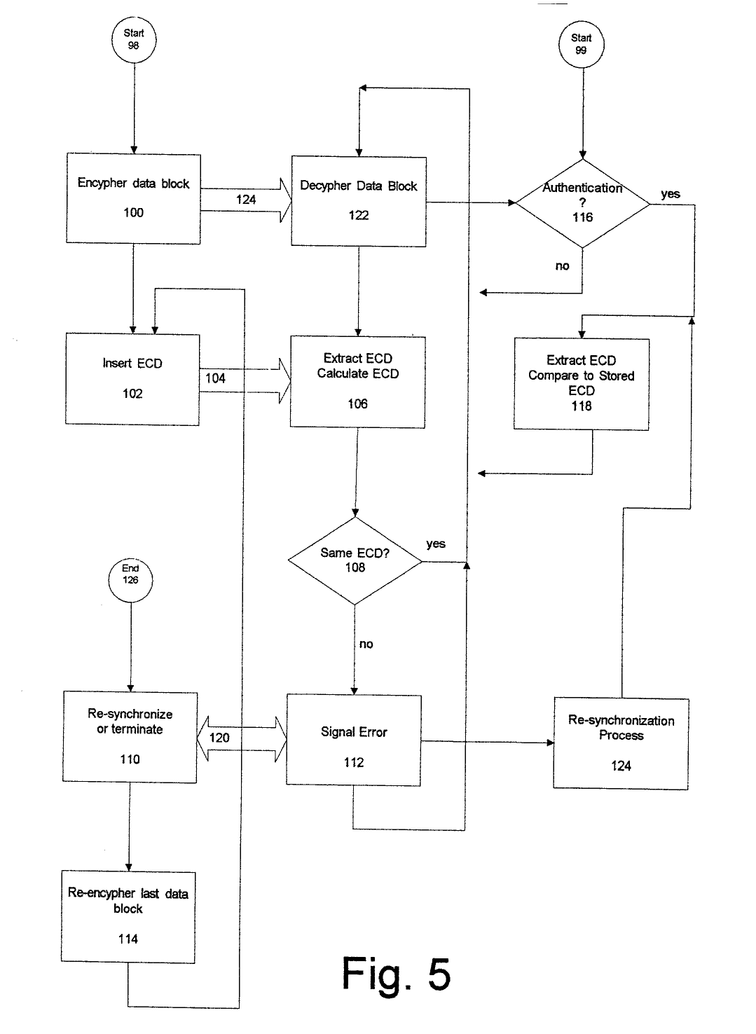

Synchronization, re-synchronization and authentication may be understood by referring to FIG. 5. The sender process start point 98 is shown, together with the receiver process start point 99. It is assumed in FIG. 5 that initialization has taken place, and the sender encrypts a data block 100 into ciphertext, which is then transmitted 124 over the communications channel to the receiver, which deciphers the data block 122. The receiver tests whether this is an authentication transmission 116, and, if so, the remote (sender's) ECD in the current transmission is compared to the local (receiver's) ECD 118. This comparison acts as an authentication to insure that the sender of the current communication is the same sender who transmitted the previous communication.

If the two are not the same 108, an error 112 is signaled 120 to the sender, who may either re-synchronize 110 or terminate the transmission 126. This decision may be based on the presence of byte-to-byte errors. In the absence of byte-to-byte errors, the sender may assume that intrusion has taken place, and terminate.

In the event of re-synchronization, which is signaled 120 to the receiver by the sender over the communication channel, a new Master Key will be generated 6 (as seen in FIG. 1) from the Master Recovery Key, using the function described in equation (5) above. The same re-synchronization process 124 takes place identically at the receiver as well. The receiver then returns to test whether authentication is being tested 116. If the sender does not request further authentication, the receiver system decrypts 122 the next data block received, extracts the ECD and tests it against the calculated ECD 106, and the process continues. Once synchronization has been restored, the Master Recovery Key can be changed using a PRN that operates on the previous Master Recovery Key and the current ciphertext block.

It should be re-emphasized that the present invention does not include algorithms for error detection and correction, but uses any of the well-known algorithms currently available for this purpose.

The ASK library is shown in its entirety in the microfiche library included as Appendix A in U.S. application Ser. No. 09/182,154, filed Oct. 29, 1998, the entire teachings of which are incorporated herein by reference.

Second Preferred Embodiment

In a simplified embodiment, the Intermediate keys are bypassed and the system generates the encryption key directly from the Master Recovery Key. Thus, a PRN function operating on the Master Recovery Key and the previous Encryption Key generates a new Encryption key after each block of cyphertext transmitted, in accordance with equation (10) below.

EK[I+1]=PRN₂(MRK, EK[I]) (10)

where

EK=Encryption key;

I=number of the cyphertext block transmitted;

PRN₂=Pseudo-random function for this embodiment; and

MRK=Master Recovery Key

As in the first preferred embodiment, entropy from the cyphertext block transmitted is added to the new Encryption key for the same purposes as previously described.

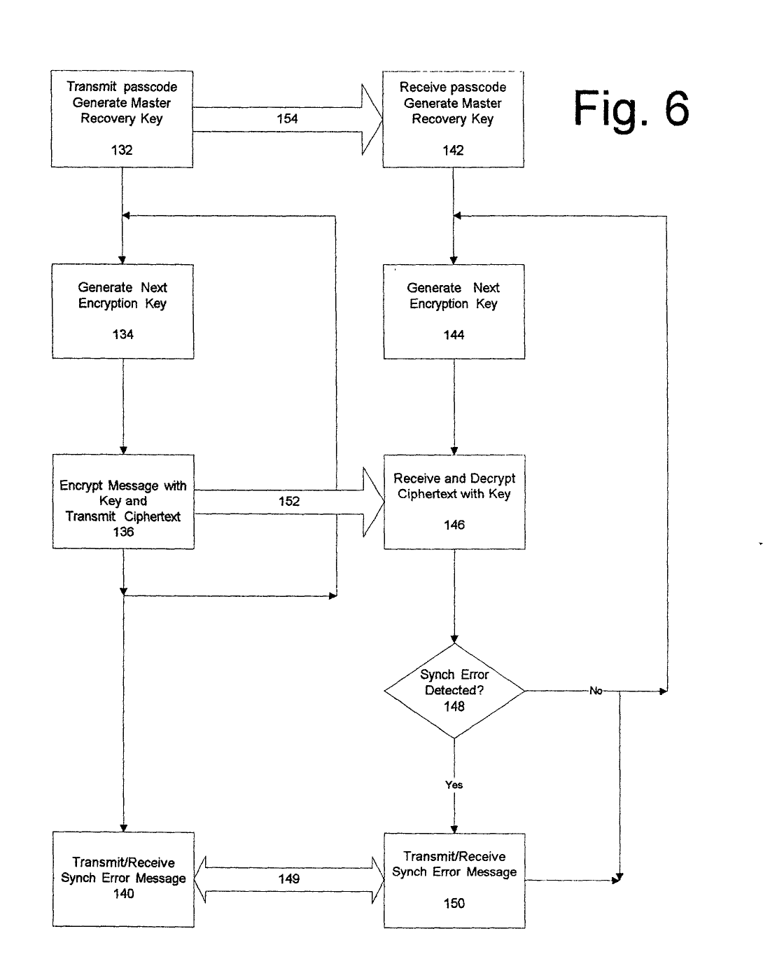

This embodiment may be understood by referring to the flowchart of FIG. 6. In this figure, the left-hand side functions represent the sender, and the right-hand side functions the receiver.

At the sender end, the passcode is first transmitted 154, and a Master Recovery Key generated from the passcode 132. Next, the Encryption Key is generated 134 in accordance with equation (10) above. The data block is the encrypted using the Encryption Key just generated, and transmitted to the receiver 136. The sender then checks for error messages 140.

At the receiver end, the passcode is received 154 and the Master Recovery Key generated from the passcode 142. The Encryption Key is generated 144. in accordance with equation (10) above. The data block is received 152 and decrypted 146 using the Encryption Key just generated. The synchronization data in the cyphertext is then tested for synchronization errors 148, and, if any are detected, the error is signaled 149 to the sender, which acknowledges the error 149.

Re-synchronization incorporating the Master Recovery Key is done as in the first preferred embodiment. Authentication in this embodiment is done in a manner similar to that of the first preferred embodiment, except that in this embodiment the authentication code is generated from the Master Recovery Key.

Third Preferred Embodiment

In a further embodiment, the Encryption key is generated directly from the Initialization string, and a PRN function operating on the previous Encryption Key generates a new Encryption key after each block of cyphertext transmitted, in accordance with equation (11) below.

EK[I+1]PRN₃(EK[I]) (10)

where

EK=Encryption key;

I=number of the cyphertext block transmitted;

PRN₃=Pseudo-random function for this embodiment; and

As in the first preferred embodiment, entropy from the cyphertext block transmitted is added to the new Encryption key for the same purposes as previously described.

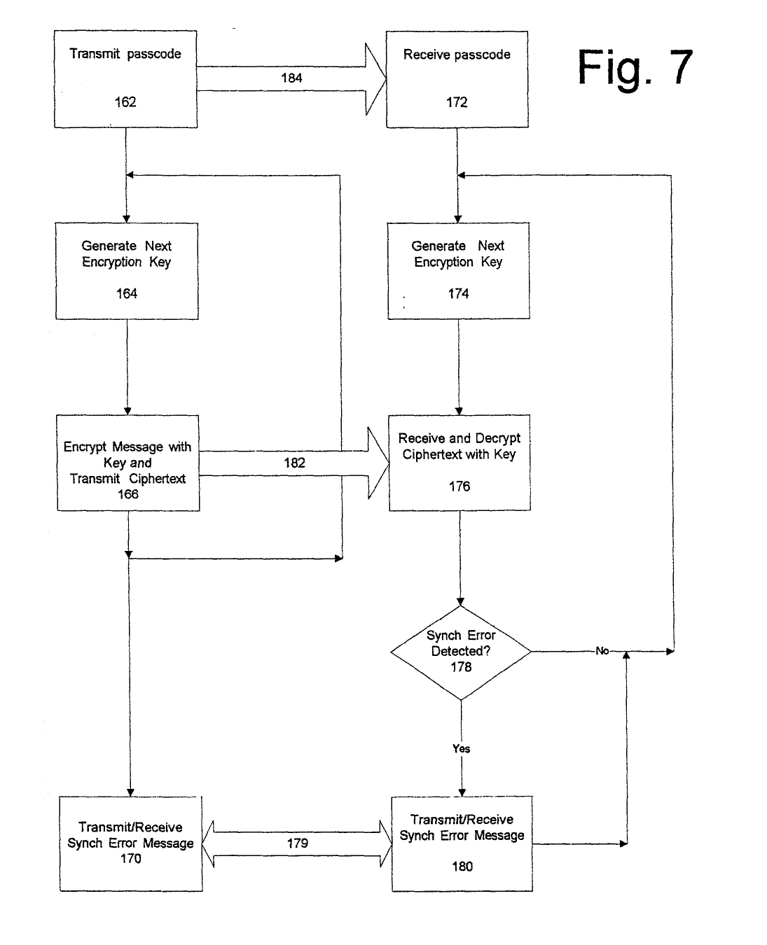

This embodiment may be understood by referring to the flowchart of FIG. 7. In this figure, the left-hand side functions represent the sender, and the right-hand side functions the receiver.

At the sender end, the passcode is first transmitted 162, and the Encryption Key is then generated 164 in accordance with equation (11) above. The data block is the encrypted using the Encryption Key just generated 166, and transmitted to the receiver 182. The sender then checks for error messages 170.

At the receiver end, the passcode is received 172 over the communications channel 184 and the Encryption Key is generated 174 in accordance with equation (11) above. The data block is received 182 and decrypted 176 using the Encryption Key just generated. The synchronization data in the cyphertext is then tested for synchronization errors 178, and, if any are detected, the error is signaled 179, 180 to the sender, which acknowledges the error 179.

Re-synchronization incorporating the Master Recovery Key is done as in the first preferred embodiment. Authentication in this embodiment is done in a manner similar to that of the first preferred embodiment, except that in this embodiment the authentication code is generated from the Initialization String, with or without the addition of entropy from the preceding block of cyphertext transmitted and received.

It will be apparent that improvements and modifications may be made within the purview of the invention without departing from the scope of the invention defined in the appended claims.

TABLE 1
Generation of the ECD Code and Insertion Into Ciphertext Block

int KeyGenerator: : Locations (BitLocations& OrderedPairs, unsigned int CFB_Size)

| { | short BitStatus [16] = {0,0,0,0,0,0,0,0,0,0,0,0,0,0,0,0}; | | // create empty array for keeping track of bit status. |
|---|---|---|---|
| | short PossibleChoices [16] ; | | // create empty array for keeping track of possible choices. |
| | short AvailableBits; | | // variable that will maintain a count of available bits. |
| | short AssignedBit; | | // variable that will contain the index of the current assigned |
| | | | bit. |
| | short FindBit; | | // index variable used for finding the assigned bit's position. |
| | unsigned char crc_mrk=MRK.CRC () ; | | // obtain Master Recovery Key's CRC. |
| | for (short BitPointer=0 ; BitPointer<16 ; Bitpointer++) | | // loop through 16 bit pointers: |
| | { | for (AssignedBit=0 , AvailableBits=0 ; AssignedBit<16 ; AssignedBit++) | // loop through useable bits: |

| | | |
|---|---|---|
| { | if (BitStatus [AssignedBit] >−1) | // if this bit is not already in use, |

| | | |
|---|---|---|
| { | PossibleChoices [AvailableBits] =AssignedBit; | // add it to the list of possibilities. |

| | |
|---|---|
| AvailableBits++; | // increment the number of available bits. |

| | } | |
|---|---|---|
| } | | |
| AssignedBit=MRK.Value.c[(crc_mrk+BitPointer) %160] %AvailableBits; | | // pick a pseudo-random number between 0 and |
| | | AvailableBits. |
| for (FindBit=0; FindBit< (AvailableBits+1) ; FindBit++) | | // loop through possible locations of the AssignedBit: |
| { | if ( FindBit==AssignedBit) | // if FindBit = AssignedBit, |

| | |
|---|---|
| OrderedPairs.Bit [BitPointer] =PossibleChoices [j] ; | // PossibleChoices[FindBit] is the pseudo-random |

| | bit-location. |
|---|---|
| } | |
| BitStatus [OrderedPairs.Bit [BitPointer] ] =−1; | // mark bit as used so that it is not re-used. |
| OrderedPairs.Word [BitPointer] = | // pick a pseudo-random number between 0 and the number |

| | of WORDS (16-bit sets) |
|---|---|
| (MRK. Value. c[ (crc_mrk+BitPointer) %160] % (CFB_Size/2) ) *2; | // in the current ciphertext block and use it as this WORD |

pointer.

}
return 1;

What is claimed is:

1. A method for symmetric-key encrypted transmission of block-organized data between a sender and receiver comprising the following steps, in order:
(a) exchanging a initialization string by secure, external means between sender and receiver;
(b) generating an encryption key by pseudo-random-function means operating on data comprising the initialization string at both sender and receiver;
(c) encrypting the next block of data into ciphertext by symmetric-key-encryption algorithm means comprising the encryption key at the sender;
(d) transmitting the ciphertext to the receiver;
(e) decrypting the ciphertext by symmetric-key-encryption algorithm means comprising the encryption key at the receiver;
(f) generating a new encryption key at both sender and receiver by pseudo-random-function means operating on data comprising the previous encryption key; and
repeating the steps from (d) forward repeatedly until the data is exhausted.

2. The method of claim 1, further comprising:
calculating synchronization data at sender and receiver by pseudo-random function means operating on data comprising the current data block;
including the synchronization data with the ciphertext transmitted to the receiver;
comparing the synchronization data received with the synchronization calculated;
signaling resynchronization requests from receiver to sender;
acknowledging resynchronization requests; and
re-executing the steps of claim 1. From step (d) forward.

3. The method of claim 2, further comprising adding entropy to new encryption key by pseudo-random-function means operating on the data block.

4. The method of claim 2, wherein the pseudo-random-function means operating on the data block further comprises function means operating on the ciphertext.

5. A method for symmetric-key encrypted transmission of data between a sender and receiver comprising the following steps, in order:
(a) exchanging a initialization string by secure, external transmission between sender and receiver;
(b) generating an encryption key by pseudo-random-function means operating on data comprising the initialization string at both sender and receiver;
(c) encrypting the next block of data into ciphertext by symmetric-key-encryption algorithm means comprising the encryption key at the sender;
(d) transmitting the ciphertext to the receiver;
(e) decrypting the ciphertext by symmetric-key-encryption algorithm means comprising the encryption key at the receiver;
(f) generating a new encryption key at both sender and receiver by pseudo-random-function means operating on data comprising the initialization string; and
repeating the steps from (d) forward repeatedly until the data is exhausted.

6. The method of claim 5, further comprising:
calculating synchronization data at sender and receiver by pseudo-random function means operating on data comprising the current data block;
including the synchronization data with the ciphertext transmitted to the receiver;
comparing the synchronization data received with the synchronization calculated;
signaling resynchronization requests from receiver to sender;
acknowledging resynchronization requests; and
re-executing the steps of claim 5 from step (d) forward.

7. The method of claim 6, further comprising adding entropy to new encryption key by pseudo-random-function means operating on the data block.

8. The method of claim 6, wherein the pseudo-random-function means operating on the data block further comprises function means operating on the ciphertext.

9. A method for symmetric-key encrypted transmission of block-organized data between a sender and receiver comprising the following steps, in order:
(a) exchanging a initialization string by secure, external means between sender and receiver;
(b) generating one or more intermediate keys by pseudo-random-function means operating on data comprising the initialization string at both sender and receiver;
(c) generating an encryption key by pseudo-random-function means operating on data comprising the intermediate keys at both sender and receiver;
(d) encrypting the next block of data into ciphertext by symmetric-key-encryption algorithm means comprising the encryption key at the sender;
(e) transmitting the ciphertext to the receiver;
(f) decrypting the ciphertext by symmetric-key-encryption algorithm means comprising the encryption key at the receiver;
(g) generating new intermediate keys at both sender and receiver by pseudo-random-function means operating on data comprising the previous intermediate keys; and
repeating the steps from (c) forward repeatedly until the data is exhausted.

10. The method of claim 9, further comprising:
calculating synchronization data at sender and receiver by pseudo-random function means operating on data comprising the current data block;
including the synchronization data with the ciphertext transmitted to the receiver;
comparing the synchronization data received with the synchronization calculated;
signaling resynchronization requests from receiver to sender;
acknowledging resynchronization requests; and
re-executing the steps of claim 9 from step (c) forward.

11. The method of claim 10, further comprising adding entropy to new encryption key by pseudo-random-function means operating on the data block.

12. The method of claim 11, wherein the pseudo-random-function means operating on the data block further comprises function means operating on the ciphertext.

13. A method for symmetric-key encrypted transmission of data between a sender and receiver comprising the following steps, in order:
(a) exchanging a initialization string by secure, external transmission between sender and receiver;
(b) generating a master recovery key by pseudo-random function means from data comprising the initialization string;
(c) generating a first intermediate key by pseudo-random-function means operating on data comprising the master recovery key at both sender and receiver;
(d) generating one or more second keys by pseudo-random-function means operating on data comprising the first intermediate key at both sender and receiver;
(e) generating an encryption key by pseudo-random-function means operating on data comprising the second intermediate keys at both sender and receiver;
(f) encrypting the next block of data into ciphertext by symmetric-key-encryption algorithm means comprising the encryption key at the sender;
(g) transmitting the ciphertext to the receiver;
(h) decrypting the ciphertext by symmetric-key-encryption algorithm means comprising the encryption key at the receiver;
(i) generating new second intermediate keys at both sender and receiver by pseudo-random-function means operating on data comprising the previous intermediate keys; and
repeating the steps from (d) forward repeatedly until the data is exhausted.

14. The method of claim 13, wherein synchronization correcting further comprises:
calculating synchronization data at sender and receiver by pseudo-random-function means operating on data comprising the current data block;
including the synchronization data with the ciphertext transmitted to the receiver;
comparing the synchronization data received with the synchronization calculated;
signaling resynchronization requests from receiver to sender;
acknowledging resynchronization requests; and
re-executing the steps of claim 13 from step (c) forward.

15. The method of claim 14, further comprising adding entropy to new encryption key by pseudo-random-function means operating on the data block.

16. The method of claim 14, wherein the pseudo-random-function means operating on the data block further comprises function means operating on the ciphertext.

17. The method of claim 14, wherein the first intermediate key comprises the Master Key, and wherein the second intermediate keys comprise the Internal key.

18. A method for generating and updating encryption keys for use in symmetric-key encrypted transmission between a sender and receiver, in which pre-existing host software includes encryption and decryption algorithms and further includes signaling means, comprising the following steps, in order:
(a) exchanging a initialization string by secure, external means between sender and receiver;
(b) generating an encryption key by pseudo-random-function means operating on data comprising the initialization string at both sender and receiver;
(c) repeating the steps from (b) forward when signaled by the host software.

19. The method of claim 18, in which the host software organizes the data in one or more data blocks, and in which the data is enciphered by the host software into ciphertext, further comprising adding entropy to new encryption key by pseudo-random-function means operating on the data block.

20. The method of claim 19, further comprising:
a) calculating synchronization data at sender and receiver by pseudo-random function means operating on data comprising the current data block;
b) including the synchronization data with the ciphertext transmitted to the receiver;
c) comparing the synchronization data received with the synchronization calculated;
d) signaling re-synchronization requests and acknowledgments between receiver and sender;
e) re-executing the steps of claim 18 from step (b) forward.

21. A method for generating and updating encryption keys for use in symmetric-key encrypted transmission between a sender and receiver, in which pre-existing host software includes encryption and decryption algorithms and further includes signaling means, comprising the following steps, in order:
a) exchanging an initialization string by secure, external means between sender and receiver;
b) generating one or more intermediate keys by pseudo-random-function means operating on data comprising the initialization string at both sender and receiver;
c) generating an encryption key by pseudo-random-function means operating on data comprising the intermediate keys at both sender and receiver;
d) generating new intermediate keys at both sender and receiver by pseudo-random-function means operating on data comprising the previous intermediate keys; and
e) repeating the steps from (b) forward repeatedly when signaled by the host software.

22. The method of claim 21, in which the host software organizes the data in one or more data blocks, and in which the data is enciphered by the host software into ciphertext, further comprising adding entropy to new encryption key by pseudo-random-function means operating on the data block.

23. The method of claim 22, further comprising:
a) calculating synchronization data at sender and receiver by pseudo-random function means operating on data comprising the current data block;
b) including the synchronization data with the ciphertext transmitted to the receiver;
c) comparing the synchronization data received with the synchronization calculated;
d) signaling re-synchronization requests and acknowledgments between receiver and sender; and
re-executing the steps of claim 18 from step (b) forward.

24. The method of claim 1, further including an authentication method which comprises generating an authentication code by function means operating on data comprising the initialization string at both sender and receiver;
transmitting the authentication code from sender to receiver, said code constituting a remote code at the receiver;
transmitting the authentication code from receiver to sender, said code constituting a remote code at the sender;
comparing the remote code to the generated code at both sender and receiver;
transmitting an authentication error from receiver to sender when the receiver remote code does not correspond to the receiver generated code; and
transmitting an authentication error from sender to receiver when the sender remote code does not correspond to the sender generated code.

25. The method of claim 9, further including an authentication method which comprises:
generating an authentication code by function means operating on data comprising one or more intermediate keys at both sender and receiver;
transmitting the authentication code from sender to receiver, said code constituting a remote code at the receiver;
transmitting the authentication code from receiver to sender, said code constituting a remote code at the sender;
comparing the remote code to the generated code at both sender and receiver;
transmitting an authentication error from receiver to sender when the receiver remote code does not correspond to the receiver generated code; and
transmitting an authentication error from sender to receiver when the sender remote code does not correspond to the sender generated code.

26. The method of claim 17, further including an authentication method which comprises:
generating an authentication code by function means operating on data comprising the Master Key at both sender and receiver;
transmitting the authentication code from sender to receiver, said code constituting a remote code at the receiver;
transmitting the authentication code from receiver to sender, said code constituting a remote code at the sender;
comparing the remote code to the generated code at both sender and receiver;
transmitting an authentication error from receiver to sender when the receiver remote code does not correspond to the receiver generated code; and
transmitting an authentication error from sender to receiver when the sender remote code does not correspond to the sender generated code.
